(19) United States
(12) Patent Application Publication
(10) Pub. No.: US 2001/0042055 A1
(43) Pub. Date: Nov. 15, 2001

(54) Parcel self-servicing machine

(76) Inventors: Jan Didriksen, Lystrup (DK); Jorn Vagn Hundeboll, Stovring (DK); Wolmer Jorgensen, Lystrup (DK); John Nymann Pedersen, Lystrup (DK); Jan Mikkelsen, Skanderborg (DK); Leif Fleming Rasmussen, Broby (DK)

Correspondence Address: BIRCH STEWART KOLASCH & BIRCH, PO BOX 747, FALLS CHURCH, VA, 22040-0747, US

(21) Appl. No.: 09/777,683

(22) Filed: Feb. 7, 2001

Related U.S. Application Data
(60) Provisional application No. 60/181,229, filed on Feb. 9, 2000.

(30) Foreign Application Priority Data
Feb. 7, 2000 (DK) PA2000 00193

(51) Int. Cl. G06F 17/00; G07B 17/02; G01G 19/413

(52) U.S. Cl. 705/407; 705/401

(57) ABSTRACT

A parcel self-servicing machine for check-in and/or delivery of items, such as mail items, library books, postal order items etc. Is capable of communicating via a global computer network. Items to be checked in or delivered may be pre-announced via the global computer network. The system may be adapted to receive payment, e.g. credit card payment. May have an item receiving unit having a cylinder shell part defining an interior cavity, the shell part having an opening defined therein for allowing items to pass between the exterior and the interior of the shell part. The system may comprise at least two storage parts for storing items and a connecting part for connecting a chosen storage part and a receiving/delivery platform. A plurality of storage parts may be arranged on a carrousel. Maintenance may be performed on the system by means of an electronic connection between an electronic service tool and the control unit of the system.

The present invention relates to a system to be used for customers for automatic check-in and/or delivery of items, in particular parcels, and a method of using such system. The system allows the customer to pay for the service with cash and/or with credit card or payment card. The system has access to a database of valid postal delivery addresses and the system validates an address given by the customer and may in particular assist the customer in finding a correct postal delivery address. The address may be printed by the system and attached to the postal item.

Optionally, a machine-readable code is attached to the postal item comprising an identification code for that particular item.

An important aspect is an item receiving unit having a pivotally arranged cylinder shell with an opening that may be aligned with an opening in a front plate in a receiving position or the shell may be turned to a discharge position wherein the shell closes the opening in the front plate.

The item check-in and/or delivery system of the present invention is further capable of providing other services, such as selling various forms of tickets, checking in return goods, such as library books, rented video cassettes or the like, and for delivering/handing out items, such as parcels or e-commerce goods.

The system of the present invention is further enabled to receive commands from a customer via a global computer network, and maintenance of the system may be provided from a remote position.

### BACKGROUND OF THE INVENTION

Automated check-in systems for postal items by which the item is weighted and postage is applied to it and paid for are known from the prior art and are disclosed in U.S. Pat. No. 4,940,887, in U.S. Pat. No. 5,313,404 as well as in U.S. Ser. No. 5,570,290. A system is disclosed in U.S. Pat. No. 5,586,037 which is able to print a destination code and/or a delivery address on a postal item or on a label to be applied to the item.

An automated check-in system for postal items is further disclosed in the co-pending international patent application with the application number PCT/DK99/00429 assigned to the assignee of the present application.

A system for validation of written delivery addresses of postal items that have been checked in into the postal delivery system by scanning the written address, use optical character recognition and compare the obtained information with a database of valid delivery addresses is known from U.S. Pat. No. 5,770,841. A postal employee is referred to by the system in case of a mismatch.

It is an advantage for the efficiency of the postal delivery system if the customer is referred to in case of a mismatch, so that the number of postal items within the postal delivery system having an invalid address is delimited. It is also an advantage for the customer to obtain assistance in finding the full and valid delivery address for a postal item when the customer does not know the full address or the correct spelling of personal names, street names or postal area codes etc.

It is further an advantage that the customer may communicate with the system and give commands to the system via a global computer network. Thus, the customer may give orders in advance and thereby save time when the postal items are actually checked in or delivered or other services are made use of.

None of the above mentioned references discloses a system which is enabled to receive commands via a global computer network. Neither does any of them disclose a system which is capable of delivering items to a customer as well as being capable of checking in items. Finally, none of the above mentioned references discloses a system on which service and/or maintenance may be provided from a remote position.

Thus, it is an object of the present invention to provide a system for postal customers to perform an automated check-in of postal items in which the item is weighted and the customer pays for the postal service, the customer communicates a postal delivery address to the system which validates the address against a database of valid postal delivery addresses and supply the address in a printed form to be applied to the postal item, wherein the system is enabled to receive commands from a customer via a global computer network.

It is a further object of the present invention to provide a system which can assist the customer in selecting a valid postal address from an input from the customer comprising only part of a postal address.

It is a still further object of the present invention to provide a system which can assist the customer in selecting a valid postal address even if part of the customer input is erroneous.

It is a yet still further object of the present invention to provide a system which can supply a machine-readable code to be applied to the postal item.

It is a yet still further object of the present invention to provide a system which can allocate a unique postal item identification code to each postal item being checked in at the system and which is enabled to communicate this identification code together with the validated delivery address to a remote computer system.

It is a yet still further object of the present invention to provide a postal item check-in system which is further capable of providing other services, such as selling various forms of tickets, checking in return goods, such as library books, rented video cassettes or the like.

It is a yet still further object of the invention to provide an item check-in and delivery system being capable of receiving items from customers as well as of delivering items to customers, and to provide service and/or maintenance to such a system from a remote position.

### DESCRIPTION OF THE INVENTION

The present invention provides a postal item check-in system comprising

a control unit having a central data processing unit, data storage means, means for communicating information to a customer, means for receiving information from a customer to the control unit, means for communicating with a global computer network, and means for OCR (optical character recognition), the system further comprising

a payment device for receiving payment from a customer, the operation of said payment device being controlled by the control unit, and

a printing device for printing a postal delivery address, the operation of said printing device being controlled by the control unit, the control unit being enabled to look up delivery addresses in a database comprising valid postal delivery addresses, validate a user-provided address, and control the operation of the printing device according to the validated address, and the control unit further being enabled to receive commands from a customer via the global computer network, the means for OCR being enabled to read a text on an item delivered to the system and communicate a content of the text to the central data processing unit.

The global computer network may be any suitable network, such as the internet.

The means for OCR may comprise, e.g. a CCD chip, a laser scanner, a conventional camera, or any other suitable device. Preferably, it further comprises suitable software for handling the output from the CCD chip, laser scanner, or conventional camera.

The system may further comprise means for identification of a customer. This may include a scanner for reading a card, such as a credit card or a smart card. The scanner may be a magnetic scanner (in case of a credit card) and/or a chip scanner (in case of a smart card) and/or any other suitable scanner, such as a laser scanner. The card may be, e.g. a credit card, a social security card, a customer card or any kind of smart card or other card containing information regarding the card holder.

In an embodiment the means for identification comprises an iris scanner and/or a finger print scanner. It may further or additionally comprise a voice recogniser and/or a code recogniser, where the code may be, e.g. a PIN code or a booking number.

The system may further be equipped with a weighting unit that is adapted for providing an output indicating the weight of a postal item placed at a weighting position of said unit to the control unit. Preferably, the weighting unit comprises conveying means for transporting the postal item to and from the weighting position and drive means for driving the conveying means, the operation of the drive means being controlled by the control unit. The weight of the postal item, such as a parcel, may be used by the control unit to compute the postage for the postal item, to reject items that are above a certain weight limit, as a criterion for a pre-sorting of the postal items that have been checked in, etc.

The payment device may comprise a card reader for reading information from credit cards and/or be enabled to receive bank notes and/or coins. In preferred embodiments of the present invention, the system is able to receive all the mentioned types of payment.

The printing device may be able to print machine-readable codes such as barcodes either directly on the postal items or on a adhesive label to be placed on the postal item by the customer or by means of an application device. The printing device may further be able to provide franking for the postal item.

The printing device preferably comprises means for positioning adhesive labels relatively to a printer unit of the printing device so that the printer unit prints on the adhesive label. The delivery address and, if enabled, a barcode and/or franking is printed on the label and is placed on the postal item by the customer. Alternatively, the system comprises a device for applying the adhesive label to the postal item.

As an alternative or supplement to the adhesive labels, the printing device may also comprise means for printing the delivery address and/or a barcode and/or franking directly on the surface of the postal item.

The system may also comprise a printing device for printing receipts to the customer. The receipts may be for the payment alone or also as a document proving the check-in of a parcel for a given delivery address at a given time, optionally also an insurance document in case the parcel has been insured.

It is an advantage if the control unit is enabled to connect at least temporarily to a data communication network so as to enable the control unit to communicate data with remote computer systems. The communication may enable the control unit to communicate with a remote computer system being able to read credit card data so as to enable the control unit to validate a credit card being entered into the credit card reader. Preferably, the communication takes place via the global computer network. Furthermore, the control unit may be enabled to communicate with a remote computer system being able to charge credit card accounts, so that the control unit is able to initiate charge of a credit card account so as to enable the control unit to receive credit card payment. Alternatively or additionally, the control unit may be able to communicate with a remote computer system having a database comprising valid postal delivery addresses.

In particular, the control unit may, according to the present invention, allocate a unique identification code to each of the postal items being checked in at the system, the control unit being able to communicate said identification code and the corresponding valid delivery address of each of said postal items to a remote computer system. The postal item is thereby entered into a general postal item handling system covering a larger geographical area such as a nation or a number of nations of which area the valid postal delivery addresses are included in the database in which the system looks up addresses.

The system may furthermore comprise means for applying a machine-readable code to each of the postal items being checked in at the system. The machine-readable code may be e.g. a barcode or another optically detectable code, a RFID (Radio Frequency IDentification) tag, etc. The machine-readable code preferably provides a significant indication of the unique identification code.

The control unit may, in a preferred embodiment of the invention, be able to use the database comprising the valid postal delivery addresses to suggest one or more valid postal delivery addresses to the customer based on partial address information received from the customer. It may even be able to suggest one or more valid postal delivery addresses to the customer if part of the information received does not comply with a valid postal delivery address comprised in the database. In a preferred embodiment the customer communicates with the system via the global computer network.

In a particular embodiment of the present invention, the system comprises an item receiving unit that in itself is an invention that may be used for check-in of postal items as well as other items, for which it is an advantage that customers may hand-in or deposit items, in particular at airports, at which the possible safety details that will be described below would be of great importance. Thus, an embodiment of the invention regards a system as described above and comprising an item receiving unit having

a cylinder shell part defining an interior cavity of said part, the shell part having an opening defined therein for allowing postal items to pass between the exterior and the interior of said part, the cylinder shell part being arranged pivotally about a substantially vertical axis of symmetry of said cylinder shell part,

a front plate part being fixedly arranged and having an opening defined therein for allowing postal items to pass the front plate part, the cylinder shell part and the front plate part being arranged in close proximity in such a way that the openings of said parts at a receiving angular position of the cylinder shell part are aligned so as to allow for postal items to pass both openings and so that the opening of said front plate part at one or more discharge angular positions of the cylinder shell part is closed by the cylinder shell part,

the item receiving unit further having drive means for turning the cylinder shell part between said angular positions, the operation of the drive means being controlled by the control unit.

The weighting unit is preferably arranged within the interior cavity of the cylinder shell part and may in particular be arranged pivotally about the same axis as the cylinder shell part and the weighting unit has a fixed angular position relatively to the cylinder shell part. The conveying means of the weighting unit may comprise an endless belt being arranged movably in a direction perpendicular to the opening defined in the cylinder shell part, the endless belt defining a substantially horizontal surface for supporting postal items.

The front plate part towards the cylinder shell part has in an advantageous design of the item receiving unit an inner surface shaped as a concave cylinder section of a radius being substantially equal to the outer radius of the cylinder shell part. The inner surface of the front plate part may, at least in one angular direction from the opening defined in the front plate part, extends over an angle being at least the size of the angle of the opening defined in the cylinder shell part, so that the inner surface at least at one angular position of the cylinder shell part covers the opening defined in the cylinder shell part.

Preferably, the system receives commands from a customer via the global network. The commands may include details regarding a postal item to be checked in, such as the destination (address), the sender, a credit card to be charged for the service or any other relevant information.

In a very preferred embodiment of the present invention the system is further adapted for selling tickets. In such an embodiment the printing device is adapted for printing said tickets. The tickets may be, e.g. tickets for social arrangements, such as theatre tickets, cinema tickets, concert tickets or the like, and/or they may be tickets for means of transport, such as train tickets, bus tickets, plane tickets and/or they may be any other suitable kind of tickets.

In case the system is adapted for selling tickets the commands received from the customer may thus include information regarding said tickets, such as the particulars regarding a social arrangement or the destination of a journey.

A system according to the above particulars may be operated as follows. When the user approaches the system a menu is presented in a display, the menu presenting various ticket categories, such as ‘theatre’, ‘cinema’, ‘public transport’, etc. Each category may comprise a number of subcategories, e.g. representing various theatre plays, movies, transport means/companies/routes etc. The user may choose category/categories and subcategory/subcategories, confirm the choice and pay the corresponding charge by means of the payment means. The system can most preferably establish an on-line connection to the relevant ticket vendor(s).

Preferably, the system is further adapted for selling stamps, in which case the printing device is adapted for printing said stamps. Most preferably, the stamp is printed directly on a postal item, but the system may also be adapted for printing stamps of any value chosen by the customer. Preferably, the system is adapted for printing special methods of mailing, such as ‘express’, ‘registered’, ‘fragile’ etc., along with the stamp, so that no special label is needed for this purpose.

Preferably, the system is even further adapted for receiving return goods and delivering said return goods for further processing. The return goods may be, e.g. library books being returned to the library or rented video cassettes, CD's or other similar items being returned to the letter. Thus, the letter may make use of the infrastructure provided by the mail system. In case the return goods is library goods the operation of the system may be performed as follows. A user approaching the system identifies himself/herself as described above. The system then presents a menu comprising a number of categories of return goods. One of these categories is ‘library books’, and this category is picked by the user. When all the books have been placed in the system (each book may advantageously be identified by a machine readable code, such as a bar code or an RFID tag), the system prints a receipt indicating that the books have been delivered to the system by the user. Optionally, the user pays for the service and/or for books which are overdue. The transaction is preferably subsequently communicated to a server positioned at the library so as to register that the books have been duly delivered by the user.

Most preferably, the global computer network is the internet. But it may alternatively be any other suitable kind of global computer network.

An aspect of the present invention regards a general item check-in system comprising

a control unit having

a central data processing unit,

data storage means,

means for communicating with a global computer network, and

means for OCR (optical character recognition), the system further comprising

an item receiving unit having

a cylinder shell part defining an interior cavity of said part, the shell part having an opening defined therein for allowing items to pass between the exterior and the interior of said part, the cylinder shell part being arranged pivotally about a substantially vertical axis of symmetry of said cylinder shell part,

a front plate part being fixedly arranged and having an opening defined therein for allowing items to pass the front plate part, the cylinder shell part and the front plate part being arranged in close proximity in such a way that the openings of said parts at a receiving angular position of the cylinder shell part are aligned so as to allow for items to pass both openings and so that the opening of said front plate part at one or more discharge angular positions of the cylinder shell part is closed by the cylinder shell part,

the item receiving unit further having drive means for turning the cylinder shell part between said angular positions, the operation of the drive means being controlled by the control unit,

the control unit further being enabled to receive commands from a customer via the global computer network,

the means for OCR being enabled to read a text on an item delivered to the system and communicate a content of the text to the central data processing unit.

The general system may further comprise a weighting unit arranged within the interior cavity of the cylinder shell part and being adapted for providing an output indicating the weight of a item placed at a weighting position of said unit to the control unit, the weighting unit comprising conveying means for transporting the item to and from the weighting position and drive means for driving the conveying means, the operation of the drive means being controlled by the control unit. The weighting unit is preferably arranged pivotally about the same axis as the cylinder shell part and the weighting unit has a fixed angular position relatively to the cylinder shell part. The conveying means of the weighting unit may further comprise an endless belt being arranged movably in a direction perpendicular to the opening defined in the cylinder shell part, the endless belt defining a substantially horizontal surface for supporting items.

The front plate part towards the cylinder shell part has preferably, as for the postal check-in system, an inner surface shaped as a concave cylinder section of a radius being substantially equal to the outer radius of the cylinder shell part. The inner surface of the front plate part may at least in one angular direction from the opening defined in the front plate part extend over an angle being at least the size of the angle of the opening defined in the cylinder shell part, so that the inner surface at least at one angular position of the cylinder shell part covers the opening defined in the cylinder shell part. Thereby the customer is provided from being able to gain any kind of access to the area behind the front plate, which for safety reasons may be very valuable for an automatic luggage check-in system of an airport and the like. The herein described general check-in system may also comprise the elements described above as being parts of the postal item check-in system. A luggage check-in system may also comprise a ticket reader or the like by means of which a customer/passenger may identify him or herself to the control unit and the printer device may print a luggage receipt to the customer.

Preferably, the means for OCR is arranged within the interior cavity of the cylinder shell part and is adapted for providing an output indicating the content of a text on an item placed within the interior cavity.

The present invention also regards a method of operating systems as described above, which method is to a large extend obvious from the description above and the examples below. In particular, the method of performing customer check-in of postal items according to the invention comprises the following steps:

the customer enters the postal item into an item receiving unit,

the customer communicates at least partial information about a postal delivery address to a control unit,

the control unit searches a database comprising valid postal delivery addresses and suggest one or more addresses to the customer, which addresses comply at least partially with the information from the customer,

the customer acknowledges one of the suggested addresses,

the customer pays for the postal service using a payment device of the system, and

a printing device controlled by the control unit prints the valid and acknowledged delivery address.

The item receiving unit may further comprise a weighting unit on which the customer enters the postal item, where after the weighting unit determines the weight of the postal item and communicates data indicating said weight to the control unit.

The method comprises also in a preferred embodiment the following steps:

the printing device prints the address on an adhesive label,

the label is delivered to the customer, and

the customer applies the label to the postal item.

The payment step may comprise the steps of:

the customer enters a credit card into a credit card reader,

the control unit communicates with a remote computer being able to validate credit cards over a data communication network so as to validate the entered credit card, and

the control unit accepts payment with the credit card in case it is found to be valid.

The payment step may further comprise the following steps:

the control unit communicates with a remote computer being able to charge credit card accounts over a data communication network, and

the control unit initiates charge of the account related to the entered credit card so as to perform a payment procedure.

The method may also comprise the following steps:

the control system allocates a unique identification code to each of the postal items being checked in at the system, and

the control system communicates the unique identification code and the corresponding valid delivery address of each of said postal items to a remote computer system over a data communication network.

It is also advantageous if the method according to the present invention further comprises the following step:

the system provides a machine-readable code to be attached to each of the postal items being checked in at the system.

In case the system to be operated comprises the above-mentioned item receiving unit the method furthermore may comprise the steps of

turning a cylinder shell part by means of drive means controlled by the control unit about a substantially vertical axis of symmetry of said cylinder shell part so that an opening defined therein is aligned with an opening defined in a front plate part that is fixedly arranged,

entering the postal item through said openings into an interior cavity defined by the cylinder shell part,

turning the cylinder shell part about an angle so that the opening defined in the cylinder shell part is aligned with one of at least one discharge stations and so that the opening defined in the front plate is closed by the cylinder shell part, and

discharging the postal item from the interior cavity to discharge station.

An endless belt is preferably arranged pivotally about the same axis as the cylinder shell part and has a fixed angular position relatively to the cylinder shell part, the endless belt being movable in a direction perpendicular to the opening defined in the cylinder shell part and defining a substantially horizontal surface for supporting postal items so that the postal item is discharged from the interior cavity by driving the endless belt by means of drive means controlled by the control unit.

In a most preferred embodiment of the method according to the invention, the weighting unit is arranged in the interior cavity for determining the weight of postal items placed on the endless belt.

The present invention further provides a method of performing customer check-in of postal items using a system as described above, the method comprising the following steps:

the customer enters relevant data to the system via a global computer network,

the customer identifies himself,

the customer enters the postal item into an item receiving unit,

the customer pays for the postal service using a payment device of the system, and

a printing device controlled by the control unit prints a delivery address.

The relevant data may comprise delivery address, particulars related to the sender, particulars relating to the size, weight etc. of the postal item, information regarding the manner in which the postal item is supposed to be delivered (express, carefully, by registered mail etc.). It may alternatively or additionally comprise information related to a certain kind of tickets which the customer may wish to purchase. Further, it may comprise information related to a certain kind of return goods, such as library books or rented video cassettes. Such information may be, e.g. the number of items to be returned, title(s) of the item(s) or any other suitable information.

The customer may identify himself (or herself) by entering a code, such as a PIN code or a booking number, or he/she may identify himself/herself by means of a suitable kind of card (credit card, customer card, social security card or the like) or by means of an iris scanner, a finger print scanner or a voice recogniser, or by any other suitable means of identification.

Preferably, the entered address is checked by the system by accessing a data base containing valid addresses. The data base is most preferably entered via the global computer network.

The present invention further provides a postal item check-in and delivery system comprising

a control unit having

a central data processing unit,

data storage means,

means for communicating information to a customer, and

means for receiving information from a customer to the control unit, the system further comprising

a payment device for receiving payment from a customer, the operation of said payment device being controlled by the control unit, and

a receiving and/or delivery platform for receiving and/or delivering postal items from/to a customer,

at least two storage parts for storing postal items which have been received from customers and/or postal items which are to be delivered to customers, and

a connecting part being enabled to connect the receiving and/or delivery platform to a chosen one of the at least two storage parts, so as to allow a postal item to be transferred in a chosen direction between the platform and the chosen storage part.

Such a system is capable of checking in as well as delivering postal items from/to customers. The system comprises at least two storage parts for storing postal items. The stored items have either been received from customers or are waiting to be delivered to customers. The stored items may be sorted into the storage parts according to e.g. destination and/or expected time of delivery (i.e. the time the customer is expected to pick up his or her postal item).

The connecting part is preferably a movable conveyor section, most preferably of the type comprising an endless conveyor belt. But it may alternatively or additionally comprise any other suitable kind of conveyor means, such as rollers, gravity conveyors and/or chutes. In case the connecting part comprises a chute, the chute is preferably of a conical shape, the storage parts being arranged in a circular or semicircular way around the lower part of the chute, so that articles may be directed towards any of the storage parts without having to physically move the chute.

When the connecting part connects the receiving and/or delivery platform to a chosen storage part an item which has recently been checked in can be moved from the receiving and/or delivery platform where the customer has positioned the item to the chosen storage part. The item is then stored at the storage part until further processing is performed. Such further processing may e.g. be moving the item along with other items to a postal centre from where the items are distributed to e.g. the relevant countries or states, counties, towns etc., and eventually to the relevant receiver.

Alternatively, an item which is being stored at the chosen storage part may be moved from the chosen storage part to the receiving and/or delivery platform. The item may then be delivered to a customer being present near the receiving and/or delivery platform. In this case the customer must of course identify himself or herself so that it is ensured that the item is delivered to the correct person.

The system may further comprise a printing device being enabled to print a postal delivery address, the operation of said printing device being controlled by the control unit. This has already been described in detail.

The receiving and/or delivery platform may comprise a weighting unit being adapted for providing an output indicating the weight of a postal item placed at the receiving and/or delivery platform. Such a weighting unit may be used for determining the weight of an item. When an item is being checked in it may be used to determine the postage needed and/or it may be used to ensure that the item eventually being positioned at the platform is the item for which postage has been paid. It is thus not possible to position a first item on the platform, purchase postage according to that item and exchange the first item with a second item being heavier, but with the postage according to the weight of the first item applied. It would be possible to detect by means of the weighting unit that the item being checked in (second item) is not the item which was initially announced (first item).

Alternatively or additionally, the weighting unit may be used to determine the weight of items being delivered to customers. In case the customer is to pay for the freight of the item, and in case the amount payable depends on the weight of the item this is very useful. The weight of the item may also be used to indicate whether the correct item is being delivered. However, more accurate methods, such as identification by means of a machine readable code, such as a bar code, will normally be applied in order to determine such matters. Finally, the weighting unit may be used to indicate whether an item is present at all at the receiving and/or delivery platform.

The receiving and/or delivery platform preferably comprises transferring means for transferring an item positioned on the platform to the connecting part. This is very useful when an item which has been checked in is to be transferred to a storage part as described above. The transferring means most preferably comprises an endless conveyor belt being positioned at the platform. When the endless belt is activated the item is moved in the direction of the movement of the endless belt. Alternatively or additionally, the transferring means may comprise pushing or pulling means for pushing or pulling an item being positioned on the platform to the connecting part.

Similarly, the connecting part preferably comprises transferring means for transferring an item positioned on the connecting part to the receiving and/or delivery platform and/or to a chosen one of the at least two storage parts. The transferring means preferably comprises an endless conveyor belt which is capable of reversing its conveying direction, so that an article being positioned at the connecting part may be moved in any of the two directions, i.e. towards the receiving and/or delivery platform or towards the chosen storage part. Alternatively or additionally the transferring means may comprise pushing or pulling means as described above.

The control unit may further be enabled to look up delivery addresses in a database comprising valid postal delivery addresses, and validate a user-provided address. This has already been further described.

The at least two storage parts may be arranged in a substantially linear configuration, in which case the connecting part is enabled to perform a corresponding substantially linear movement in order to connect the receiving and/or delivery platform and a chosen storage part. In this case the connecting part is preferably mounted on linear conveying means, and the connection between the receiving and/or delivery platform and the chosen storage part may not be established instantly. That is, the following may happen. After an item has been positioned at the platform a connection is established between the platform and the connecting conveyor. Then the item is transferred from the platform to the connecting part, and the connecting part, carrying the item, is moved in order to establish a connection between the connecting part and the chosen storage part. The connection between the connecting part and the platform may be interrupted during this operation. When the connection between the connecting part and the chosen storage part is established the item is transferred from the connecting part to the storage part.

Alternatively, the at least two storage parts may be arranged in a substantially circular or semicircular configuration, in which case the connecting part is enabled to perform a corresponding substantially circular movement in order to connect the receiving and/or delivery platform and a chosen storage part. In this case the receiving and/or delivery platform is preferably capable of performing a pivotal movement about a substantially vertical axis, and the connecting part is preferably capable of performing a pivotal movement around the same axis, so that the movements of the two correspond to each other. The axis most preferably extends through and substantially normal to an item supporting surface of the platform. The axis is furthermore preferably positioned at or near a centre position of the platform, so that the connecting part performs a circular or semicircular movement having a larger radius than the circular or semicircular movement of the platform.

Alternatively, the at least two storage parts may be arranged movably on a frame, and the storage parts may be moved in order to connect a chosen storage part and the connecting part. In this case a plurality of storage parts may be arranged on a ‘carrousel’, and the ‘carrousel’ may be turned in order to move a certain subpart of the plurality of storage parts into the vicinity of the connecting part. When the ‘carrousel’ has been turned so that a desired storage part is in the vicinity of the connecting part, the connecting part may subsequently be moved so as to establish a connection between the receiving and/or delivery platform and the desired storage part. Thus, said connection is established as a result of a combination of the movement of the ‘carrousel’ and the connecting part.

The connecting part may comprise level adaptation means for adapting the level of the connecting part to the level of a chosen storage part. The system may thus be capable of using storage parts being positioned at different levels, thus allowing for a better utilisation of the space available around the system. The level adaptation means most preferably comprises elevator means, so that the whole connecting part carrying an item may be elevated or lowered from the level of the receiving and/or delivery platform to the level of the chosen storage part. Alternatively, the level adaptation means may comprise one or more chutes so that the platform may be connected to storage parts for receiving items, the storage parts being positioned at a lower level, e.g. in a basement, and/or so that the platform may be connected to storage parts for storing items to be delivered, the storage parts being positioned at a higher level. The connecting part may in this case comprise a pivotally movable chute being capable of switching between a position in which it establishes a connection to a chute which conveys articles from a higher level and a position in which it establishes a connection to a chute which conveys articles to a lower level.

The system may further comprise an item receiving and/or delivering unit having

a cylinder shell part defining an interior cavity of said part, the shell part having an opening defined therein for allowing postal items to pass between the exterior and the interior of said part, the cylinder shell part being arranged pivotally about a substantially vertical axis of symmetry of said cylinder shell part,

a front plate part being fixedly arranged and having an opening defined therein for allowing postal items to pass the front plate part, the cylinder shell part and the front plate part being arranged in close proximity in such a way that the openings of said parts at receiving and/or delivery angular position of the cylinder shell part are aligned so as to allow for postal items to pass both openings and so that the opening of said front plate part at one or more discharge and/or delivery angular positions of the cylinder shell part is closed by the cylinder shell part, the item receiving and/or delivery unit further having drive means for turning the cylinder shell part between said angular positions, the operation of the drive means being controlled by the control unit.

In this case the connecting part is most preferably also pivotally movable about the substantially vertical axis of symmetry of the cylinder shell part.

The invention further provides a method of delivering items from an item delivery system, the system comprising a control unit, a delivery platform, at least two storage parts for storing items to be delivered to customers, and a connecting part being enabled to connect the delivery platform to a chosen one of the at least two storage parts, the connecting part comprising drive means being controlled by the control unit, the method comprising the steps of

a customer identifying himself or herself,

the control unit identifying an item to be delivered,

the control unit identifying the storage part containing the item to be delivered,

the system conveying the item from said storage part via the connecting part to the delivery platform,

the customer receiving the item.

The delivery system may e.g. be a system as described above.

The customer may identify himself or herself by means of a customer card, a credit card, a personal password or code, a machine readable code, a voice recogniser, an iris scanner, a finger print scanner, a signal being sent from e.g. the customer's cellular telephone, such as an SMS message and/or in any other suitable way.

The control unit may identify the item to be delivered by means of a machine readable code, such as a bar code or a transponder, being attached to the item. The control unit may consult a database in which the code of the item is linked to the information relating to the customer which may be obtained when the customer identifies himself or herself. Such a database preferably further comprises information regarding which storage part contains the item, so that the connecting part may be moved into a position in which it establishes a connection between that storage part and the delivery platform, so that the item may be moved from the storage part to the platform as described above. After this has been performed the customer may pick up the item from the platform.

The step of identifying the storage part containing the item to be delivered may comprise the step of determining whether the connecting part is currently connecting the delivery platform and said storage part, and the conveying step may comprise the step of moving at least part of the connecting part so as to interconnect the delivery platform and said storage part in case the connecting part is not currently connecting the delivery platform and said storage part. That is, if the connecting part is already establishing a connection between the platform and the storage part containing the item, the item may readily be transferred to the platform for delivery to the customer. If the connecting part on the other hand is not establishing such a connection, the connection must be established before the item may be moved to the platform.

The storage parts may be positioned at different levels in which case the movement of the connecting part will comprise substantially vertical and/or pivotal movements in order to be able to establish connections to storage parts being positioned at different levels as described above.

The system may further comprise a printing device, in which case the method further may comprise the step of the printing device printing a receipt to the customer. This is particularly useful in case the customer needs to provide payment before he or she may receive the item as will be further described below.

The method may further comprise the step of advising the customer that an item is to be delivered at the item delivery system. This step may be performed using a global computer network. The customer may thus receive an electronic message, e.g. an e-mail message, from the system that an item is waiting to be delivered at a particular system. Alternatively or additionally, the advising step may be performed by the system sending a message to a cellular telephone. This may be a so-called SMS message. When the customer subsequently needs to identify himself or herself at the system he or she may send another SMS message to the system indicating that he or she is now positioned near the delivery platform, and that he or she is ready to pick up the item, which may therefore be transferred from the storage part to the delivery platform. Alternatively, the cellular telephone may automatically send a message to the system when the cellular telephone, and hence the customer, is positioned near the delivery platform, the telephone in this case only needing to be turned on. A very local network may thus be established between the cellular telephone and the control unit of the system, e.g. by means of the Wireless Application Protocol (WAP).

The system may further comprise a payment device for receiving payment from a customer, and the method may further comprise the step of the customer providing payment before the item is delivered. This may be relevant in case the customer is to pay for the freight of the item, including the situation where sufficient postage was not applied by the sender. It may further be relevant in case the item to be delivered was ordered from a postal order company or via e-commerce, and the customer needs to pay for the item being delivered. In this case the vendor may subsequently receive the payment for the item from the company providing the system.

The payment device may comprise a card reader for reading information from credit cards, and the method may further comprise the steps of

the customer entering a credit card into the payment device,

the control unit validating the credit card, and

the control unit charging the credit card in case the credit card is valid.

The system may be connected to a global computer network, in which case the validating step is performed using the global computer network.

This and alternative ways of providing payment have already been described.

The invention further provides a method of performing maintenance and/or service on an item check-in and/or delivery system, the system comprising a control unit having means for communicating with service personnel, the method comprising the steps of

the service personnel establishing an electronic connection between an electronic service tool and the control unit of the system,

the service personnel performing the maintenance and/or service required via the established electronic connection using the electronic service tool, and

the service personnel disrupting the established connection.

The check-in and/or delivery system is preferably a system as described above.

The electronic service tool may form an integrated part of a computer, either a laptop computer which the service personnel carries to the site of the system or a stationary computer being connected to the control unit of the system via a computer network as will be described further below. It may alternatively or additionally comprise a telephone (stationary or cellular), a palm pilot, various measuring devices, such as voltmeters, amperemeters, oscilloscopes, and/or any other suitable kind of tools. It may also comprise software for reading the input(s) from the device(s), analysing said input(s) and performing service and/or maintenance according to the input(s).

The step of establishing an electronic connection may comprise establishing a connection between a central computer positioned at a service centre and the control unit of the system by means of a global computer network. In this case the service tool may form an integrated part of the central computer, or it may be electronically connected to the central computer, e.g. by means of a wire, an infrared connection, a telecommunication connection and/or any other suitable electronic connection. The global computer network may be a public computer network, such as the world wide web or the internet, or it may be a closed computer network involving only a limited number of computers, e.g. only the central computer and a limited number of identical systems. In this embodiment the service and/or maintenance may be performed from a remote place, e.g. from the position of the central computer. Alternatively, a remote connection may be established between the service tool and the central computer in addition to the connection between the central computer and the control unit of the system. In this case the personnel may be positioned in the vicinity of the system needing maintenance. However, software being present on the central computer may be necessary in order to perform at lest part of the service and/or maintenance, and this software may thus be obtained via the respective connections.

The step of establishing an electronic connection may alternatively or additionally comprise establishing a wireless connection between the electronic service tool and the control unit of the system. The wireless connection may be an infrared connection, in which case the service tool may be a hand held service tool, e.g. in the form of a palm pilot, a cellular telephone, a wireless computer mouse, a laptop computer, or any other suitable kind of hand held tool.

Alternatively or additionally, the step of establishing an electronic connection may comprise establishing a connection via a telecommunication network. The telecommunication network may be a stationary telecommunication network, or it may be a cellular telecommunication network. The connection may be established by means of a modem or it may be established using a telephone directly. It may also be established by connecting a telephone to a computer network, e.g. by means of the Wireless Application Protocol (WAP) or a similar technology.

Alternatively or additionally, the step of establishing an electronic connection may comprise establishing a connection between a first central computer positioned at a service centre and a second central computer being connected to a plurality of item check-in and delivery systems, the system needing maintenance and/or service being one of said plurality of systems.

The second central computer is preferably a server device which is connected to each of the plurality of systems. The service and/or maintenance may be of a kind which is to be applied to all of the plurality of systems, e.g. installation or upgrading of software, routine checks etc. In this case the service and/or maintenance may be performed on all of the plurality of systems while the connection between the first central computer and the second central computer is established. The service and/or maintenance may even be performed substantially simultaneously on all of the plurality of systems.

The step of performing the maintenance and/or service required may comprise preparation in connection with on-location maintenance and/or service. In this case the service personnel may establish a connection to the control unit of the system either before he/she leaves home, or when he/she is on-location in the vicinity of the system, or even while being en route. The service personnel may need to obtain information regarding the function of the system, such as the number of failures of the different parts of the system (e.g. the printing device, the conveyor belts, the weighting device etc.), the number of failures of the software of the control unit, the wear and tear of the mechanical parts (e.g. how old are they and how much have they been used-i.e. are any mechanical part liable of needing exchange in the near future, and is any part causing trouble/failure due to wear and tear). The obtained information may be used to determine which part(s) need(s) service/maintenance so that the service personnel need not spend time on this while being on-location. It may also provide information relating to the amount and kind of spare parts and/or completely new part(s) the service personnel needs to bring in order to perform the service/maintenance. Thus, valuable time is saved since the personnel does not have to leave the site in order to fetch the necessary spare parts, and he/she does not have to order the spare parts and wait for them to arrive from the manufacturer. Thus, the service/maintenance may be performed with a minimum waist of time without having to maintain a large storage of various spare parts which may even be expensive.

If the system further comprises a weighting unit for weighting the items being checked in or delivered, the step of performing maintenance and/or service may comprise the step of calibrating the weighting unit. This may be done from a remote position in case the weighting unit is of the kind comprising an induction coil.

The step of performing maintenance and/or service may comprise installation of software in the control unit of the system. This includes installation of new software and/or upgrading of software being already installed in the control unit. It may also include a total re-installation of all the software being installed in the control unit.

### BRIEF DESCRIPTION OF THE FIGURES

FIG. 1 is a diagram of a parcel check-in system according to the invention,

FIG. 2 shows the customer front-end of the system,

FIG. 3 shows four positions of a receiving unit for receiving items,

FIG. 4 shows four positions of a receiving unit similar to the one of FIG. 3 but with a different design of the front plate part,

FIG. 5 shows four states of operation of a conveyor belt with photo cells for receiving items,

FIG. 6 shows a perspective view of a check-in system comprising the receiving unit of FIGS. 3 and 4.

FIG. 7 is a diagram showing the main components of the control unit,

FIG. 8 shows a schematic view of an on-line postal item check in system,

FIG. 9 shows a perspective view of an embodiment of the check-in system according to the invention comprising a connecting part,

FIG. 10 is top view of the check-in system of FIG. 9, and

FIGS. 11 and 12 show perspective views of a check-in system in combination with a plurality of storage parts.

### DETAILED DESCRIPTION OF THE FIGURES

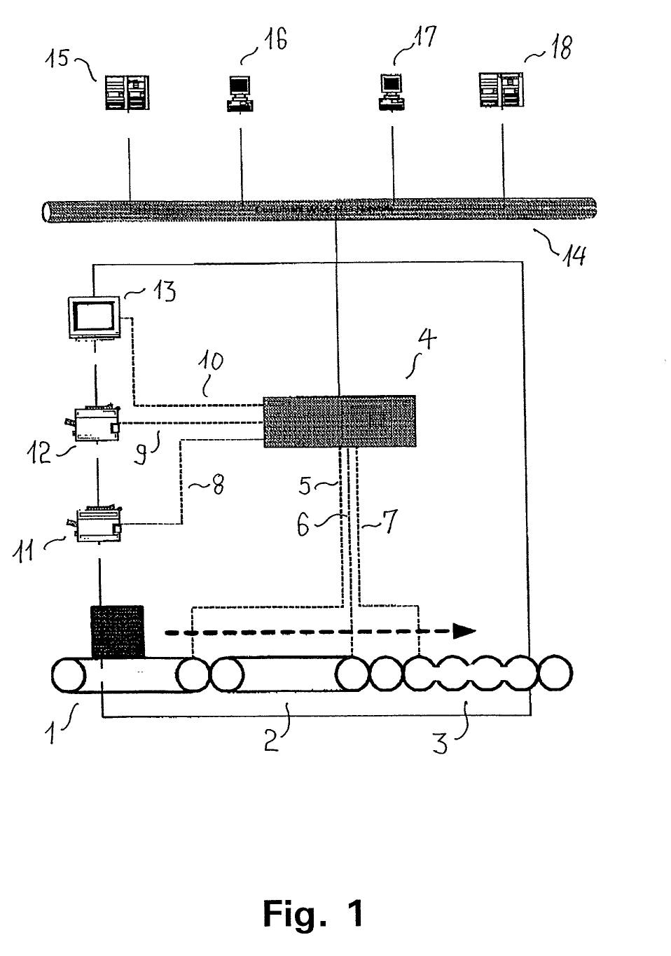

The parts of a parcel check-in system according to the invention are shown on the diagram in FIG. 1. The system comprises an inlet conveyor belt section 1, a static weighting section 2 having a conveyor belt, the weighting section 2 being able to provide an electronic output indicating the weight of an article placed on the belt, and an accumulating conveyor section 3 for receiving and temporarily storing parcels from the weighting section 2, the three sections 1-3 being arranged in series. Each of the three sections 1-3 comprises a drive unit, an asynchronous electric motor, for driving the article conveying means of the respective section. The weighting section 2 is preferably placed in an area to which customers do not have access.

The operation of the system is controlled by a control unit 4, which is a multiple-purpose computer having a central processing unit, data storage means and data communication means 5-10, and being provided with suitable computer software stored in the data storage means for controlling the operation of the computer. The control unit 4 has data communication means 5-7 being adapted for transferring data for controlling the operation of the drive units of the three sections 1-3 and for receiving data from sensors arranged along the sections 1-3. It further has data communication means 8, 9 being adapted for transferring control data from the control unit 4 to a label printer 11 and to a receipt printer 12, respectively, and for transferring status data from the label printer 11 and the receipt printer 12 to the control unit 4. The system comprises a payment unit 13 for receiving payment from the customers in the form of a machine-readable credit card or payment card, such as a smart card, and optionally also in the form of bank notes and/or coins, as well as a data communication means 10 associated with the payment unit 13 for transferring data back and forth between the payment unit 13 and the control unit 4.

The control unit 4 is permanently or temporarily connected to a communication network 14, which may be a wide area network (WAN) by which the control unit 4 may communicate with remote external systems. The external systems shown are a postal central computer system 15 having a database containing all registered valid postal addresses within a given geographical area, such as one or more states, one or more countries, etc., and a look-up table connecting each active unique postal item identification code with a valid postal address, an automatic maintenance system 16 which keeps the computer software updated/upgraded and monitors the operational state of the check-in system for errors, lack of supplies of labels etc., a test system 17 from which a remote on-line troubleshooting and diagnosing can be performed, and a credit card and/or payment card system 18 from which a validation of cards can be obtained and where the customers account can be charged.

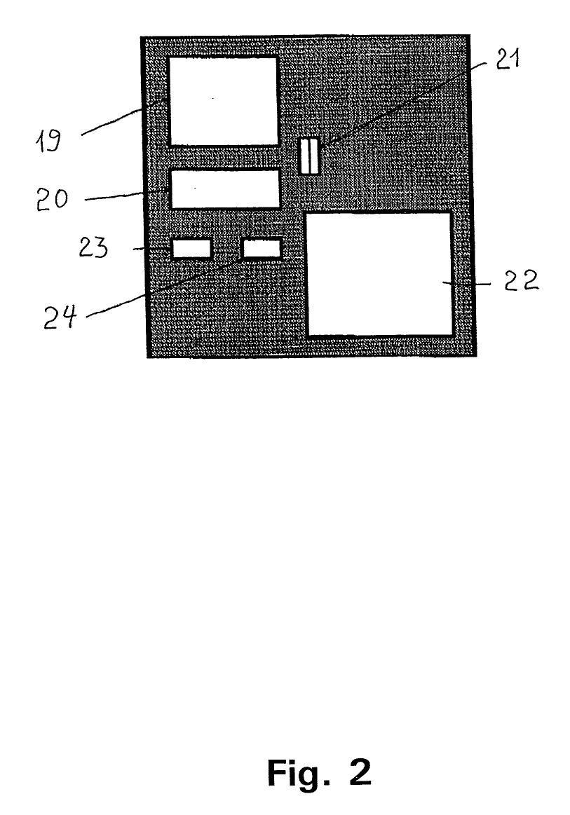

The customer front-end shown in FIG. 2 has a monitor 19 and a keyboard 20 of the control unit 4 for providing means for communication between the system and the customer. The monitor 19 has optionally a touch-sensitive screen, thus making the keyboard 20 unnecessary. A card reader 21 for reading credit cards etc. is placed on the front-end for receiving payment from the customers, and the front-end optionally also has a unit for receiving bank notes and/or coins. An opening 22 is provided for entering parcels onto the inlet belt conveyor section 1. The opening 22 is preferably of a size so that parcels exceeding certain dimensions cannot be entered. In particular, the plane of the opening may be situated in a plate laying in a plane that is substantially parallel to the article-supporting plane of the inlet belt conveyor section 1 so that only parcels complying with the dimension requirements in all three dimensions may be entered into the system. Further, the front-end has openings 23, 24 through which the output from the label printer 11 and the receipt printer 12, respectively, can be delivered to the customer. The printed label has the validated address printed on it and comprises a unique postal item identification code assigned to the particular parcel in a machine-readable form, such as a bar code, an RFID transponder, a series of alphanumeric characters to be read by Optical Character Recognition (OCR), etc. The application of the label on the parcel is performed by the customer but could instead be performed by an automatic applicator. However, at present such applicators are high-priced and their performance are not sufficiently reliable when dealing with irregularly shaped parcels.

The customer begins the operation of the parcel check-in system by placing a parcel onto the inlet belt conveyor section 1 through the associated opening 22 in the front-end of the system. The operation of the drive unit of the inlet belt conveyor section is started by the control unit 4 and the parcel is conveyed to the static weighting section 2 of which the drive unit is activated as well, until the parcel is at a correct position on the weighting section 2. The position of the parcel is controlled by a photocell, which is activated when the front end of the parcel reaches a given position along the weighting section 2. The photocell sends an output to the control unit 4 when it is activated so that the control unit can stop the operation of the drive units of the input conveyor section 1 and the weighting section 2 at an appropriate moment. Optionally, a number of photocells are arranged around the weighting section 2 so that the dimensions of the parcel may be measured or at least controlled to be within a given set of limits. The weighting section 2 transmits an electronic output to the control unit 4 indicating the weight of the parcel. The control unit displays the measured weight to the customer on the monitor 19 and activates the drive means of the input belt conveyor section 1 and the weighting section 2 in a reverse direction so as to convey the parcel back onto the input belt conveyor section 1. The position of the parcel on the input belt conveyor section 1 is controlled by a photocell which is activated and sends an output to the control unit 4 when the front end of the parcel reaches a given position along the input belt conveyor section 1.

The control unit 4 prompts via the monitor 19 the customer for entering a credit card into the card reader 21. The entered card is read by the card reader and the identification data of the card is transmitted to the control unit 4 which performs a validation procedure over the network with the credit card system 18. When the card is validated, the customer is prompted to enter the delivery address or at least part of the delivery address on the keyboard. The control unit 4 has access to a database of valid postal addresses, either from the postal central computer 15 over the network or from a locally stored and regularly updated copy of the database. The control unit 4 can by using the database assist the customer in finding the correct address by proposing a number of valid addresses found in the database from deficient address information entered by the customer.

The database of valid postal addresses may in a simple form comprise an index of valid street names for each district with a postal code, e.g. ZIP-code, optionally also valid house numbers and flat indications on those streets. More elaborate databases also comprise the names of the residents of those addresses. The database may also comprise information about the mail route each postal address is designated to.

The validation of addresses and assistance for the user in finding a valid address depends on the specification level of the database employed. The assistance and validation system may be enabled to recognise faulty or alternative spelling of personal names and street names so that the name “Smith” in a database search will be regarded as belonging to the group of “Smith, Schmidt, Smidth, Schmith, Schmitt, . . . ,” etc. and be able to suggest one or more valid addresses from a limited number of information of which perhaps none are completely correct.

The customer input device of the system may additionally or alternatively to the keyboard or the touch-sensitive screen comprise means for speech recognition and/or an Optical Character Recognition system for scanning an address that is already written on the parcel.

The customer may after having confirmed the address enter additional categorisation of the parcel, such as “fragile” or “express”, enter the contents of the parcel and/or insure the parcel. The control unit 4 calculates the total charge and the customer confirms the amount and enters if required a PIN-code for the card. The control unit 4 charges the account of the entered card by communicating over the network with the credit card/payment card system 18.

The parcel is allocated a unique postal item identification code and the control system communicates the code together with the validated address, the identification code of the check-in system and the optional categorisation to the postal central computer system 15 in which it is added to the relevant database. The code is used for sorting of the parcels and for monitoring and tracking of the parcel through the postal parcel delivery system.

A label is printed on the label printer 11 and a receipt is printed on the receipt printer 12 and the label and the receipt are delivered to the customer through the respective front-end openings 23, 24. The customer applies the adhesive label to the parcel and communicates to the system that the parcel is ready. The parcel is conveyed from the inlet belt conveyor section 1 to the weighting section 2 and the parcel is weighted again to ensure that the parcel has not been tampered with, e.g. been exchanged with a heavier parcel, and a scanner controls that the identification code is placed so that it actually is machine-readable. The parcel is then conveyed to the accumulating conveyor section 3 from where it is entered into the postal parcel delivery system.

The parcel may alternatively not be allocated a unique postal item identification code but instead have a machine-readable code printed on the label containing information about the partial or complete address and optionally also about the mail route the address is designated to, or the parcel may not be given a machine-readable code at all. Such a system does not necessarily have to be connected to a network, especially not if only payment means are accepted that do not require access to a central payment system 18, such as cash, cash cards or certain smart-cards.

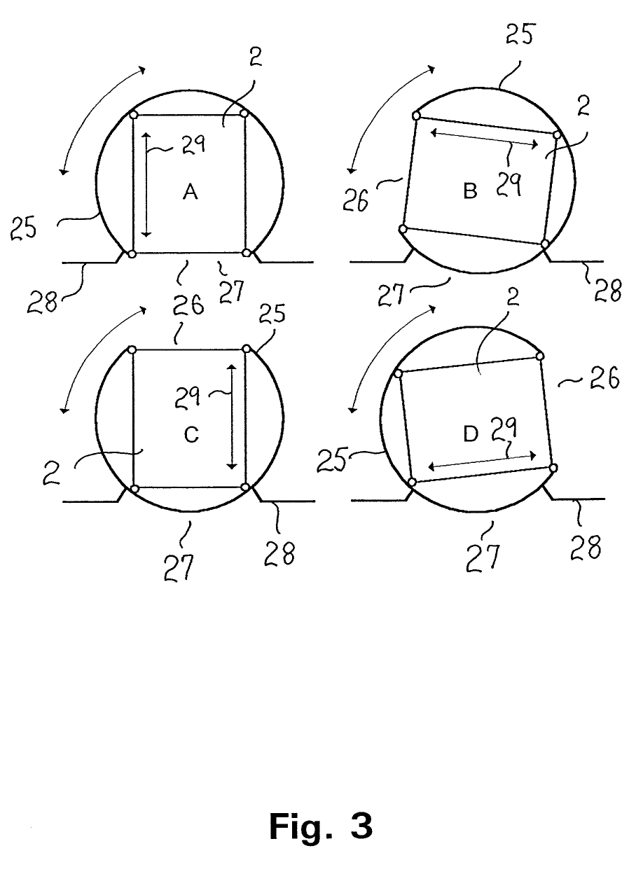

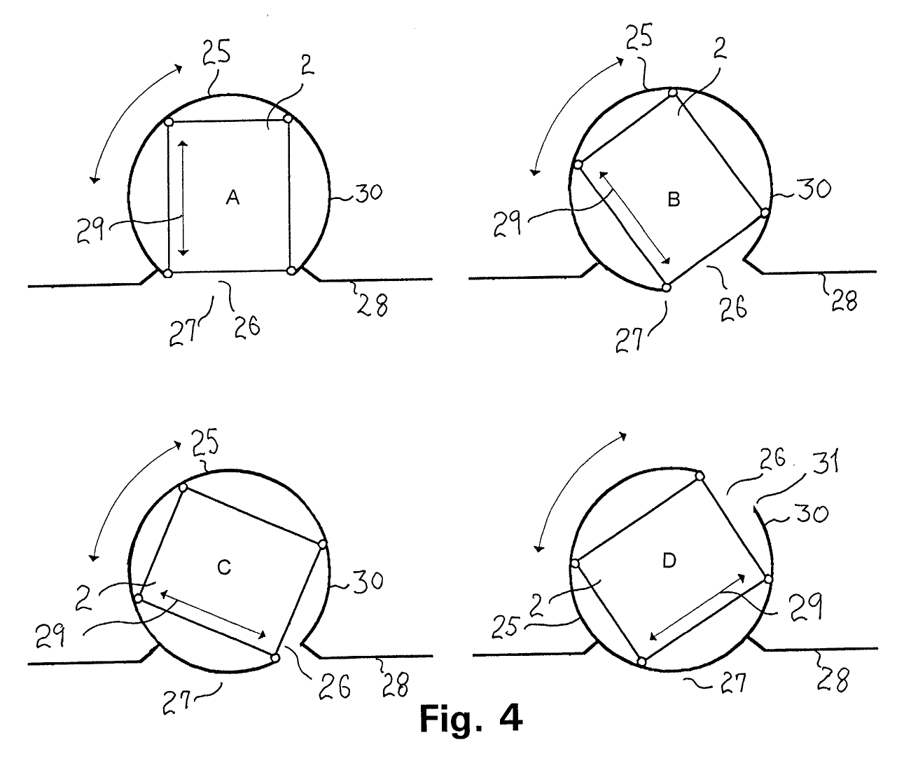

Another embodiment of the parcel receiving part of the system is shown in FIGS. 3 and 4 according to which the weighting section 2 is arranged within a pivotally arranged screen part 25 formed as a cylinder shell. The screen part 25 has an opening 26 defined therein for allowing parcels to be entered into the screen part 25 and onto the weighting section 2 and for allowing the parcels to be discharged again. A corresponding opening 27 is defined in the front plate 28 of the receiving part so that the two openings 26, 27 may be aligned in a receiving angular position of the cylinder shell screen part 25 as shown in FIG. 3 position A and in FIG. 4 position A.

Four positions of one embodiment of the system with a screen part 25 formed as a cylinder shell are shown in FIG. 3 as positions A, B, C and D. Position A is as mentioned above a receiving position in which the opening 26 of the screen part 25 is aligned with the opening 27 of the front plate 28 to allow a customer to enter a parcel to be checked in onto the weighting section 2 that is arranged within the screen part 25 in such a way that it is turned together with the screen part and the transport direction (indicated with an arrow 29) of the conveyor belt of the weighting section 2 constantly is perpendicular to the opening 26 in the shell part. In positions B, C and D, the screen part 25 is turned about its pivot axis, which is identical with the vertical symmetry axis of the cylinder shell, by means of an electrical stepper motor that is controlled by the control unit to three different angular discharge positions in which the parcel that was placed on the weighting section 2 at position A may be discharged. The plurality of discharge positions allows for a pre-sorting of the parcels according to a set of criteria such as the dimensions of the parcels, the destination, express parcels, insurance of the parcels, parcels for courier service, etc. or a combination of such criteria. The pre-sorting can be very advantageous as the different types of parcels often are handled by means of different handling arrangements and accumulation space for the parcels may be utilised more efficiently if small parcels are sorted into a bulk storage means such as a wire container or a mail bag so that they do not take up space on accumulation conveyors for larger parcels.

Four angular positions A-D of a screen part 25 arranged according to another embodiment of the invention are shown in FIG. 4. In this embodiment, the front plate 28 has an extension part 30 that on the inner side towards the screen part 25 is formed as a counterpart to the outer shape of the screen part 25 so that the two parts 25, 30 fit closely together. The extension part 30 extends over an angle that is at least equal to the angular size of the opening 26 defined in the screen part 25 so that the extension part 30 can cover said opening 26 and prevent that an opening is formed between the customer area and the area to which customers do not have access during the operation of the system. From the receiving position of the screen part 25 as shown in position A of FIG. 4, the screen part 25 is turned counter-clockwise towards one of the discharge positions. This operation is illustrated in positions B, C and D of FIG. 4, in which the screen part 25 is turned in incrementing angular steps from the receiving position. The opening 26 in the screen part 25 is partly aligned with the opening 27 in the front plate 28 at position B and C, and the remaining part of the opening 26 in the screen part 25 is covered by the extension part 30. At position D, the opening 26 in the screen part 25 is no longer aligned with the opening 27 in the front plate 28 and an opening is forming between the rear edge 31 of the extension part 30 and the opening 26 in the screen part 25. The screen part 25 may be turned to one, two or more different discharge stations arranged in the area to which customers do not have access. The number of discharge stations can not be more than two for the shown dimensioning of the parts of the system but the number may be three or more, depending mainly on the angular size of the opening 26 defined in the screen part 25 of the system.

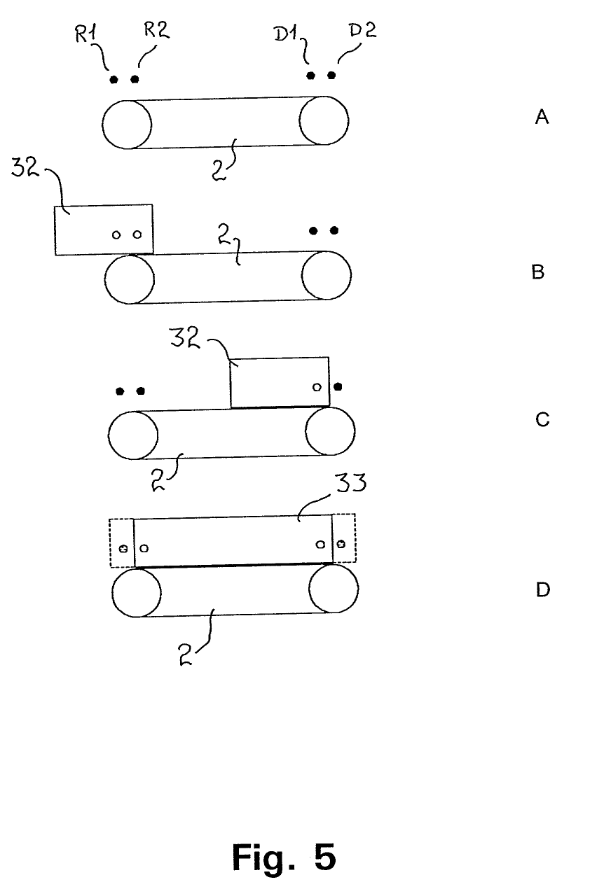

An arrangement of photocells, R1, R2, D1, D2 in relation to the weighting section 2 and the operation of the section 2 in accordance with the output from the photocells R1, R2, D1, D2 is shown in FIG. 5. The weighting section 2 is shown in position A without a parcel present so that the two photocells R1, R2 at the receiving end of the section 2 as well as the two photocells D1, D2 at the discharge end of the section 2 are visible. The reference numbers for the photo cells R1, R2, D1, D2 are not included in positions B-D. A parcel 32 is entered onto the receiving end of the weighting section 2 in position B. The two photo cells R1, R2 at the receiving end are blocked off and the conveyor belt of the weighting section 2 is operated until the first photo cell D1 at the discharge end of the weighting unit is blocked off which indicates to the control unit of the system, to which the output from the photo cells R1, R2, D1, D2 are directed, that the parcel 32 has reached a weighting position and the operation of the conveyor belt is halted as shown in position C. The longitudinal size of the parcel is measured at the same time based on the time between the second photo cell R2 at the receiving end is no longer blocked off and the first photo cell D1 at the discharge end is blocked off as well as the conveying speed of the belt. The second photo cell D2 at the discharge end of the weighting section 2 is used to ensure that the conveyor belt is not operated for too long a period, in which case the conveying direction may be reversed and the belt being operated until the photo cell D2 is no longer blocked off, and also to ensure that the parcels 32 are actually fully discharged from the section 2.

The photo cell D2 may also be used in case a long parcel 33 is entered onto the weighting section 2 as shown at position D. The parcel 33 illustrated with the continuous line has the maximum length allowable for the system and is in the correct weighting position blocking off two of the photo cells R2, D1. The two remaining photo cells R1, D2 are used to ensure that the parcel 33 is not too long and extends beyond the allowable limits of the weighting unit.

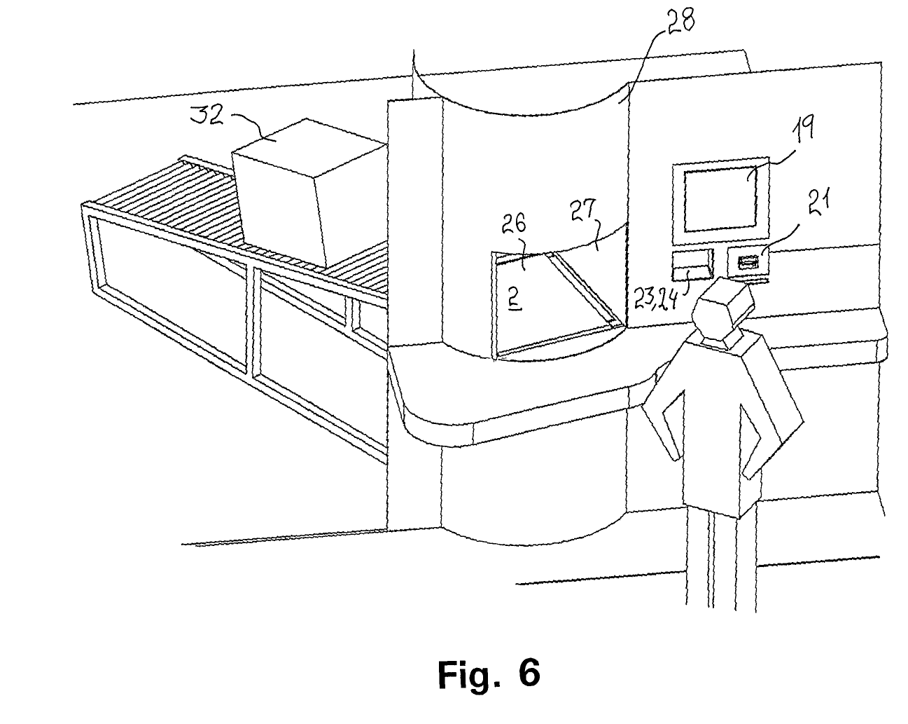

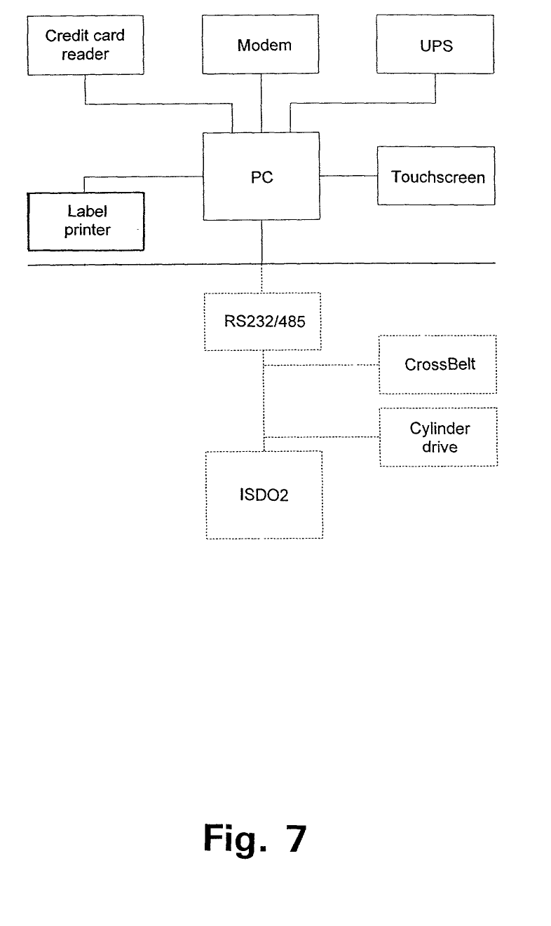

The control of the operation of main parts of the system is illustrated in FIG. 6. The control unit of the system is constituted by a Personal Computer (PC) having a central processing unit and data storage means comprising Random Access Memory (RAM) as well as a physical storage medium, a hard disc. The PC is connected to a Credit card reader for receiving payment from the customers, a modem for communicating with remote computer systems via a communication network, a UPS that ensures that the system is closed down properly in case of a power failure, a label printer for printing the delivery address on adhesive labels to be applied to the parcels by the customer and for printing receipts and a Touch-screen for interaction with the customer so that information from the control unit to the customer are shown on the screen and the customer can provide information input to the control unit by touching sensitive parts of the screen. The control of the drive means for driving the cross belt, or conveyor belt, of the weighting unit and possibly other conveyor belts, the control of the drive means for turning the cylinder shell shaped screen part 25 and the receiving of output from the photo cells R1, R2, D1, D2 is performed via an RS 232/485 interface to a subsidiary control part ISD02 through which the actual control is performed.

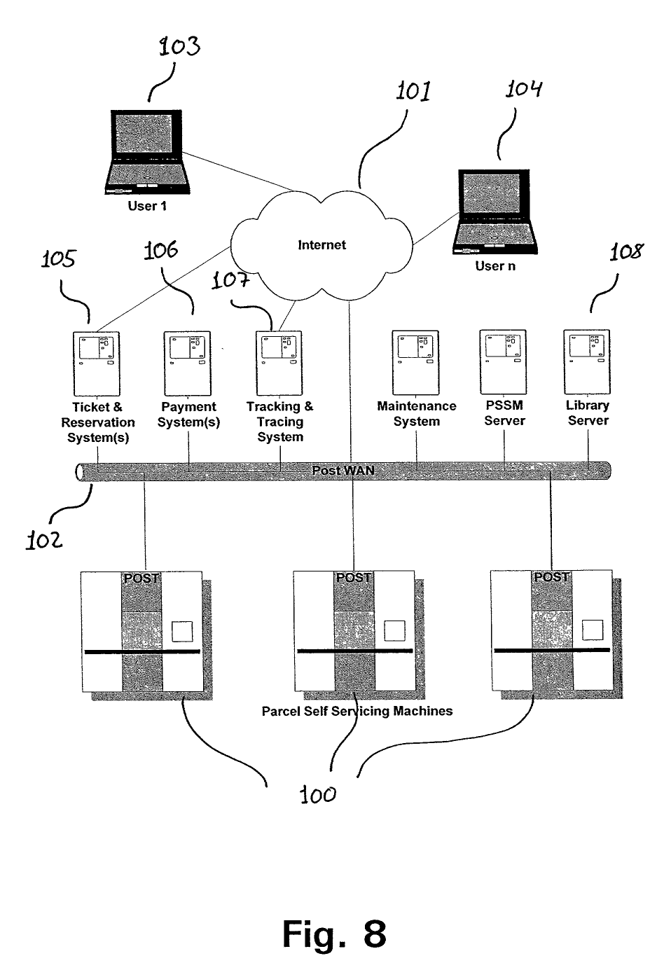

FIG. 8 shows how postal item check-in systems 100 are connected to a global computer network 101 via a Post WAN system 102, and the users 103,104 are in contact with the postal item check-in systems 100.

In a embodiment of the invention the communication of commands flows from the users 103,104 via the global computer network to different service systems, such as a ticket and reservation system 105, a payment system 106, a tracking and tracing system 107, or a library server 108, depending on the wanted operation.

By communicating via the global computer network the user 103,104 is able to reserve tickets, prepare sending of a parcel, and when the user 103,104 afterwards identifies him/herself to one of the postal item check-in systems 100 the system 100 will communicate with the relevant service system to require the necessary information and perform the user specified operation, such as receiving payment and printing tickets, checking in the parcel, or the like.

A user 103, 104 who uses the postal item check-in system 100 on a regular basis may generate a file in the system, the file containing information regarding a number of receiving addresses which the user 103, 104 has used, such as addresses used within a specific time interval preceding the present or the last, e.g. 10, addresses used. When the user 103, 104 communicates with the postal item check-in system 100 and identifies himself/herself in order to announce that a parcel is to be checked in, the system 100 will enter the file and present the addresses contained therein to the user 103, 104. The user 103, 104 may then pick one of the addresses, or he/she may choose to enter an address which is not currently contained in the file. In the latter case the file is automatically updated so as to contain the additional address.

The user 103, 104 may pre-announce that one or more parcel(s) is/are to be checked in via e.g. a personal computer being connected to the system 100 via the global computer network 101. When the user 103, 104 at a later time approaches one of the postal item check-in systems 100 and identifies himself/herself, the system 100 will list the parcel(s) which has/have been pre-announced, and the user 103, 104 will be asked to enter the first parcel, then the second etc. until all the parcels have been checked in.

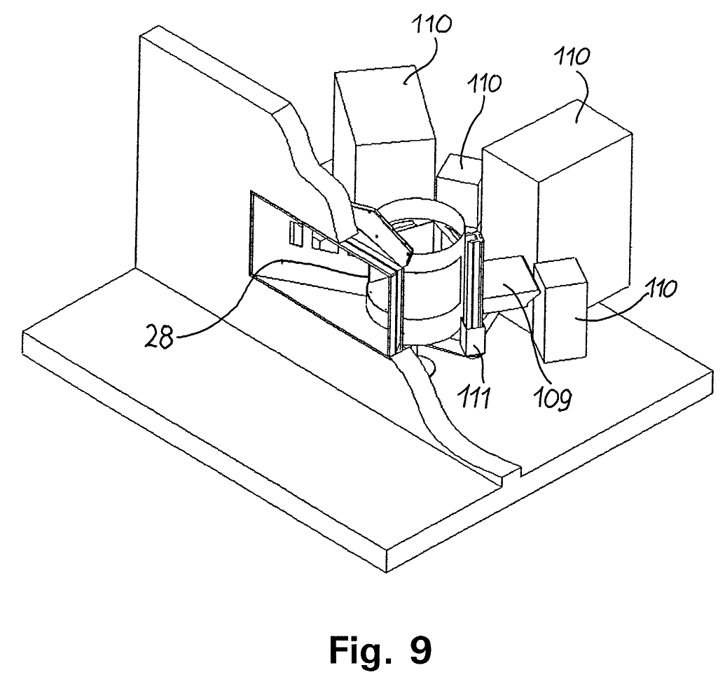

FIGS. 9-12 illustrate embodiments of the postal item check-in system, wherein the parcel receiving part of the system has a cylinder shell part. The parcel receiving part comprises a connecting section 109 which is positioned behind the front plate part 28, i.e. it is unavailable for a customer using the system.

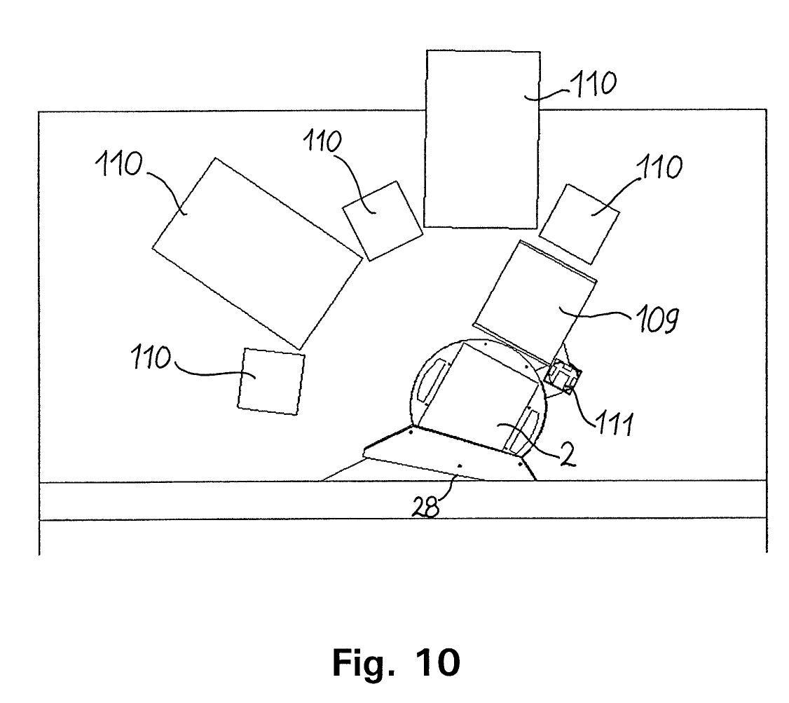

In FIGS. 9 and 10 the parcel receiving part further comprises five storage parts 110, each of which may be connected to a weighing section 2 being positioned inside the cylinder shell part by means of the connecting section 109. The connecting section 109 is provided with a conveyor belt and drive means for driving the conveyor belt, so that items may be conveyed by the connecting section 109. The connecting section 109 is further provided with elevator means 111, so that the level of the connecting section 109 may be adjusted according to the storage part 110 to which it shall be connected. As can be seen from FIG. 9, the storage parts 110 may be positioned at different levels, and they may be of different sizes in order to accommodate different kinds of parcels, e.g. having different sizes.

The parcel receiving part may be used for check-in of articles and/or for delivering articles to the customer. In case the parcel receiving part is used for check-in, it is operated substantially as described above until the parcel is to be conveyed away from the weighting section 2. At this point the cylinder is turned until the conveying directions of the weighting section 2 and the connecting section 109 are aligned, as indicated in FIGS. 9 and 10. The cylinder is then turned along with the connecting section 109, and subsequently the connecting section 109 is optionally elevated/lowered by means of the elevator means 111, until a connection is established to a chosen storage part 110. The connecting section 109 is turned around the same axis around which the cylinder shell part is turned. The chosen storage part 110 is the one which shall accommodate the received item. The item is then conveyed by means of the weighting section 2 and the connecting section to the chosen storage part 110. The parcel receiving part then return to a position in which it is ready to receive another item. Preferably, the connecting section 109 subsequently automatically returns to an initial position from where it is ready to perform the above operations again. This may be performed while the next session begins, e.g. while the next customer enters an item into the parcel receiving part or while the next customer identifies himself/herself in order to be allowed to pick up an item being stored at one of the storage parts. This will save operation time.

In case the parcel receiving part is used for delivering an item to a customer, it is preferably operated as follows. The customer approaches the parcel receiving unit and identifies himself/herself. The parcel receiving unit then identifies an item which is to be delivered to that customer, and it identifies the storage part 110 which accommodates that item. The cylinder and the connecting section 109 are then moved as described above so as to establish a connection between the weighting section 2 and the storage part 110 accommodating the item. The item is then conveyed by means of the connecting section 109 and the weighting section 2 from the storage part 110 to the weighting section 2. Finally, the cylinder is turned into a position in which the customer may pick up the item from the weighting section 2. Optionally, in case payment is required from the customer, he/she may provide such payment using the payment device of the parcel receiving part before the item is delivered. The items being delivered may be ordinary postal items, such as parcels, but it may also be ordered goods, e.g. goods bought by means of e-commerce or library books, rented video cassettes or any other suitable kind of goods. In any case the distributor makes use of the infra structure provided by the item check-in system.

Preferably, the customer is advised in advance that an item is to be delivered at a specific parcel receiving part. This may be performed by delivering a note at the customers home address, but it may alternatively be performed by sending an electronic message to the customer, such as an e-mail, an SMS message or any other kind of message sent to the customer's cellular telephone or PC. In case a message is sent to the customer's cellular telephone, the customer may identify himself/herself at the parcel receiving part by merely turning on the cellular telephone, the telephone thereby transmitting a signal identifying said telephone and hence the customer carrying it, e.g. by means of the Wireless Application Protocol (WAP) or using a similar technology.

In a further embodiment of the invention the communication is performed over the world wide web, a global network or the internet.

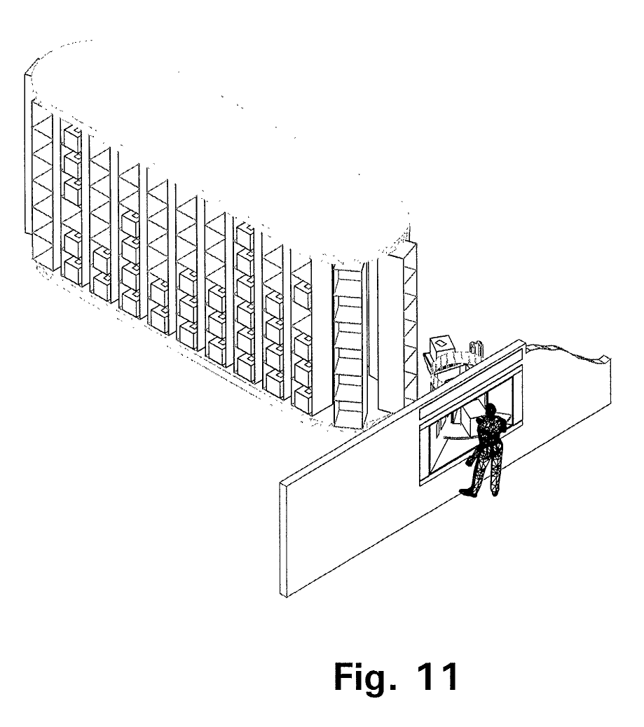

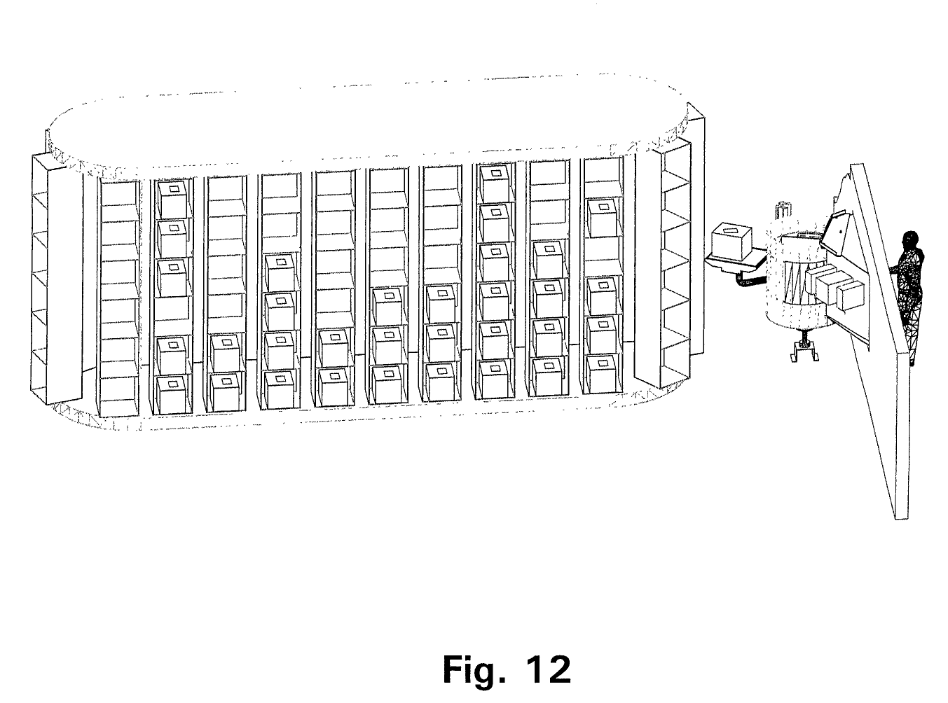

FIGS. 11 and 12 show perspective views of a check-in and delivery system comprising a plurality of storage parts 110 arranged on a carrousel 112. The carrousel 112 comprises a number of storage sections 113, each comprising six storage parts 110 in the form of shelves. In the shown embodiment check-in as well as delivery of articles from/to a customer as described above is possible. Preferably, each storage part 110 has a unique ID. When an article is checked in (or delivered for later delivery to a customer) and subsequently positioned in a storage part, the ID of the article is linked to the ID of the storage part, so that the system will know where a specific article is located. Thus, in case the article is to be delivered to a customer, the system will be able to locate and deliver the correct article when the customer turns up.

Check-in of articles is performed as described above until the article is to be moved away from the connecting part 109. Then an empty storage part 110 is identified, and in case the identified empty storage part 110 is not in the vicinity of the connecting part 109, the carrousel 112 is moved in such a way that the empty storage part 110 is in the vicinity of the connecting part 109. The connecting part 109, and optionally the elevator means 111, are moved so as to connect the connecting part 109 and the chosen empty storage part 110. Finally, the article is transferred from the connecting part 109 to the chosen storage part 110. At this time at the latest the ID of the storage part 110 is linked to the ID of the article, so that the article may be located at a later time as described above. Based on the ID of the article the system may obtain additional information relating to the article, such as destination or other relevant information as described above. The ID of the storage part 110 may thus be linked to this additional information as well, or the system may use the information when handling the article.

The checked-in articles may be collected, e.g. by a truck or lorry. In this case the driver may extract information from the system relating to which articles have been checked in for further distribution, and he may empty the storage parts 110 containing such articles only. The driver may additionally deliver articles which are to be delivered by a customer from the system in question at a later time. This will be described further below.

Delivery of articles may be performed in the following way. A customer approaches the system and identifies himself/herself as described above. The system then identifies and locates the article which is to be delivered to the customer. If the storage part 110 containing the identified article is not in the vicinity of the connecting part 109 the carrousel 112 is moved until the storage part 110 is in the vicinity of the connecting part 109. The connecting part 109, and optionally the elevator means 111, are moved so as to connect the storage part 110 and the connecting part 109. The article is transferred to the connecting part 109, and the article is subsequently moved to the delivery platform as described above in order to be delivered to the customer.

In case a truck or lorry delivers articles to be delivered to customer this is preferably performed as follows. The driver has access to the back part of the system where he enters the articles in empty storage parts 110 and makes sure that the ID of each article is linked to the ID of the storage part 110 containing the article. This may e.g. be performed using a scanning device for scanning an electronic ID of each article as well as an electronic ID of a storage part 110 before the article is positioned in the storage part 110.

A letter check-in system similar to the described parcel check-in system can also be constructed according to the invention.

1. A postal item check-in system comprising
a control unit having
a central data processing unit,
data storage means,
means for communicating information to a customer,
means for receiving information from a customer to the control unit,
means for communicating with a global computer network, and
means for OCR (optical character recognition),
the system further comprising
a payment device for receiving payment from a customer, the operation of said payment device being controlled by the control unit, and
a printing device being enabled to print a postal delivery address, the operation of said printing device being controlled by the control unit, the control unit being enabled to look up delivery addresses in a database comprising valid postal delivery addresses, validate a user-provided address, and control the operation of the printing device according to the validated address, and the control unit further being enabled to receive commands from a customer via the global computer network,
the means for OCR being enabled to read a text on an item delivered to the system and communicate a content of the text to the central data processing unit.

2. A system according to claim 1, further comprising means for identification of a customer.

3. A system according to claim 2, wherein the means for identification comprises an iris scanner.

4. A system according to claim 2, wherein the means for identification comprises a finger print scanner.

5. A system according to claim 1, further comprising a weighting unit being adapted for providing an output indicating the weight of a postal item placed at a weighting position of said unit to the control unit.

6. A system according to claim 5, wherein the weighting unit comprises conveying means for transporting the postal item to and from the weighting position and drive means for driving the conveying means, the operation of the drive means being controlled by the control unit.

7. A system according to claim 1, wherein the payment device comprises a card reader for reading information from credit cards.

8. A system according to claim 1, wherein the payment device is enabled to receive bank notes and/or coins.

9. A system according to claim 1, wherein the printing device further is able to print machine-readable codes.

10. A system according to claim 1, wherein the printing device further is able to provide franking for the postal item.

11. A system according to claim 1, wherein the printing device comprises means for positioning adhesive labels relatively to a printer unit of the printing device so that the printer unit prints on the adhesive label.

12. A system according to claim 11, further comprising a device for applying the adhesive label to the postal item.

13. A system according to claim 1, wherein the printing device further comprises means for printing on the postal item.

14. A system according to claim 1, the system comprising a printing device for printing receipts to the customer.

15. A system according to claim 1, wherein the control unit is able to validate credit card data via the global computer network so as to enable the control unit to validate a credit card being entered into the credit card reader.

16. A system according to claim 15, wherein the control unit is able to charge credit card accounts via the global computer network, the control unit being able to initiate charge of a credit card account so as to enable the system to receive credit card payment.

17. A system according to claim 1, wherein the control unit can communicate via the global computer network with a database comprising valid postal delivery addresses.

18. A system according to claim 1, wherein the control unit can allocate a unique identification code to each of the postal items being checked in at the system, the control unit being able to communicate said identification code and the corresponding valid delivery address of each of said postal items via the global computer network.

19. A system according to claim 18, wherein the system comprises means for applying a machine-readable code to each of the postal items being checked in at the system.

20. A system according to claim 19, wherein the machine-readable code provides a significant indication of the unique identification code.

21. A system according to claim 1, wherein the control unit is enabled to suggest one or more valid postal delivery addresses to the customer based on partial address information received from the customer.

22. A system according to claim 21, wherein the control unit is enabled to suggest one or more valid postal delivery addresses to the customer if part of the information received does not comply with a valid postal delivery address comprised in the database.

23. A system according to claim 1, wherein the system further comprises an item receiving unit having
a cylinder shell part defining an interior cavity of said part, the shell part having an opening defined therein for allowing postal items to pass between the exterior and the interior of said part, the cylinder shell part being arranged pivotally about a substantially vertical axis of symmetry of said cylinder shell part,
a front plate part being fixedly arranged and having an opening defined therein for allowing postal items to pass the front plate part, the cylinder shell part and the front plate part being arranged in close proximity in such a way that the openings of said parts at a receiving angular position of the cylinder shell part are aligned so as to allow for postal items to pass both openings and so that the opening of said front plate part at one or more discharge angular positions of the cylinder shell part is closed by the cylinder shell part,
the item receiving unit further having drive means for turning the cylinder shell part between said angular positions, the operation of the drive means being controlled by the control unit.

24. A system according to claim 23, the system comprising a weighting unit being adapted for providing an output indicating the weight of a postal item placed at a weighting position of said unit to the control unit, the weighting unit being arranged within the interior cavity of the cylinder shell part.

25. A system according to claim 24, wherein the weighting unit is arranged pivotally about the same axis as the cylinder shell part and the weighting unit has a fixed angular position relatively to the cylinder shell part.

26. A system according to claim 25, wherein the weighting unit comprises conveying means for transporting the postal item to and from the weighting position and drive means for driving the conveying means, the operation of the drive means being controlled by the control unit, and wherein the conveying means of the weighting unit comprises an endless belt being arranged movably in a direction perpendicular to the opening defined in the cylinder shell part, the endless belt defining a substantially horizontal surface for supporting postal items.

27. A system according to claim 23, wherein the front plate part towards the cylinder shell part has an inner surface shaped as a concave cylinder section of a radius being substantially equal to the outer radius of the cylinder shell part.

28. A system according to claim 27, wherein the inner surface of the front plate part at least in one angular direction from the opening defined in the front plate part extends over an angle being at least the size of the angle of the opening defined in the cylinder shell part, so that the inner surface at least at one angular position of the cylinder shell part covers the opening defined in the cylinder shell part.

29. A system according to claim 1, wherein the system receives commands from a customer via the global network.

30. A system according to claim 1, wherein the system is further being adapted for selling tickets, and wherein the printing device is adapted for printing said tickets.

31. A system according to claim 1, the system further being adapted for selling stamps, and wherein the printing device is adapted for printing said stamps.

32. A system according to claim 31, wherein the stamp is printed directly on a postal item.

33. A system according to claim 1, the system further being adapted for receiving return goods and delivering said return goods for further processing.

34. A system according to claim 1, wherein the global computer network is the internet.

35. An item check-in system comprising
a control unit having
a central data processing unit,
data storage means,
means for communicating with a global computer network, and
means for OCR (optical character recognition),
the system further comprising
an item receiving unit having
a cylinder shell part defining an interior cavity of said part, the shell part having an opening defined therein for allowing items to pass between the exterior and the interior of said part, the cylinder shell part being arranged pivotally about a substantially vertical axis of symmetry of said cylinder shell part,
a front plate part being fixedly arranged and having an opening defined therein for allowing items to pass the front plate part, the cylinder shell part and the front plate part being arranged in close proximity in such a way that the openings of said parts at a receiving angular position of the cylinder shell part are aligned so as to allow for items to pass both openings and so that the opening of said front plate part at one or more discharge angular positions of the cylinder shell part is closed by the cylinder shell part,
the item receiving unit further having drive means for turning the cylinder shell part between said angular positions, the operation of the drive means being controlled by the control unit,
the control unit further being enabled to receive commands from a customer via the global computer network,
the means for OCR being enabled to read a text on an item delivered to the system and communicate a content of the text to the central data processing unit.

36. A system according to claim 35, further comprising a weighting unit arranged within the interior cavity of the cylinder shell part and being adapted for providing an output indicating the weight of a item placed at a weighting position of said unit to the control unit, the weighting unit comprising conveying means for transporting the item to and from the weighting position and drive means for driving the conveying means, the operation of the drive means being controlled by the control unit.

37. A system according to claim 36, wherein the weighting unit is arranged pivotally about the same axis as the cylinder shell part and the weighting unit has a fixed angular position relatively to the cylinder shell part.

38. A system according to claim 37, wherein the conveying means of the weighting unit comprises an endless belt being arranged movably in a direction perpendicular to the opening defined in the cylinder shell part, the endless belt defining a substantially horizontal surface for supporting items.

39. A system according to claim 35, wherein the front plate part towards the cylinder shell part has an inner surface shaped as a concave cylinder section of a radius being substantially equal to the outer radius of the cylinder shell part.

40. A system according to claim 39, wherein the inner surface of the front plate part at least in one angular direction from the opening defined in the front plate part extends over an angle being at least the size of the angle of the opening defined in the cylinder shell part, so that the inner surface at least at one angular position of the cylinder shell part covers the opening defined in the cylinder shell part.

41. A system according to claim 35, wherein the means for OCR is arranged within the interior cavity of the cylinder shell part and being adapted for providing an output indicating the content of a text on an item placed within the interior cavity.

42. A system according to claim 35, wherein the global computer network is the internet.

43. A method of performing customer check-in of postal items using a system according to any of the preceding claims, the method comprising the following steps:
the customer enters relevant data to the system via a global computer network,
the customer enters the postal item into an item receiving unit,
the customer identifies himself,
the customer pays for the postal service using a payment device of the system, and
a printing device controlled by the control unit prints a delivery address.

44. A postal item check-in and delivery system comprising
a control unit having
a central data processing unit,
data storage means,
means for communicating information to a customer, and
means for receiving information from a customer to the control unit,
the system further comprising
a payment device for receiving payment from a customer, the operation of said payment device being controlled by the control unit, and
a receiving and/or delivery platform for receiving and/or delivering postal items from/to a customer,
at least two storage parts for storing postal items which have been received from customers and/or postal items which are to be delivered to customers, and
a connecting part being enabled to connect the receiving and/or delivery platform to a chosen one of the at least two storage parts, so as to allow a postal item to be transferred in a chosen direction between the platform and the chosen storage part.

45. A system according to claim 44, further comprising a printing device being enabled to print a postal delivery address, the operation of said printing device being controlled by the control unit.

46. A system according to claim 44, wherein the receiving and/or delivery platform comprises a weighting unit being adapted for providing an output indicating the weight of a postal item placed at the receiving and/or delivery platform.

47. A system according to claim 44, wherein the receiving and/or delivery platform comprises transferring means for transferring an item positioned on the platform to the connecting part.

48. A system according to claim 44, wherein the connecting part comprises transferring means for transferring an item positioned on the connecting part to the receiving and/or delivery platform and/or to a chosen one of the at least two storage parts.

49. A system according to claim 44, wherein the control unit is further enabled to look up delivery addresses in a database comprising valid postal delivery addresses, and validate a user-provided address.

50. A system according to claim 44, wherein the at least two storage parts are arranged in a substantially linear configuration, and wherein the connecting part is enabled to perform a corresponding substantially linear movement in order to connect the receiving and/or delivery platform and a chosen storage part.

51. A system according to claim 44, wherein the at least two storage parts are arranged in a substantially circular or semicircular configuration, and wherein the connecting part is enabled to perform a corresponding substantially circular movement in order to connect the receiving and/or delivery platform and a chosen storage part.

52. A system according to claim 44, wherein the at least two storage parts are arranged movably on a frame, and wherein the storage parts may be moved in order to connect a chosen storage part and the connecting part.

53. A system according to claim 44, wherein the connecting part comprises level adaptation means for adapting the level of the connecting part to the level of a chosen storage part.

54. A system according to claim 44, wherein the system further comprises an item receiving and/or delivering unit having
a cylinder shell part defining an interior cavity of said part, the shell part having an opening defined therein for allowing postal items to pass between the exterior and the interior of said part, the cylinder shell part being arranged pivotally about a substantially vertical axis of symmetry of said cylinder shell part,
a front plate part being fixedly arranged and having an opening defined therein for allowing postal items to pass the front plate part, the cylinder shell part and the front plate part being arranged in close proximity in such a way that the openings of said parts at receiving and/or delivery angular position of the cylinder shell part are aligned so as to allow for postal items to pass both openings and so that the opening of said front plate part at one or more discharge and/or delivery angular positions of the cylinder shell part is closed by the cylinder shell part, the item receiving and/or delivery unit further having drive means for turning the cylinder shell part between said angular positions, the operation of the drive means being controlled by the control unit.

55. A method of delivering items from an item delivery system, the system comprising a control unit, a delivery platform, at least two storage parts for storing items to be delivered to customers, and a connecting part being enabled to connect the delivery platform to a chosen one of the at least two storage parts, the connecting part comprising drive means being controlled by the control unit, the method comprising the steps of
a customer identifying himself or herself,
the control unit identifying an item to be delivered,
the control unit identifying the storage part containing the item to be delivered,
the system conveying the item from said storage part via the connecting part to the delivery platform,
the customer receiving the item.

56. A method according to claim 55, wherein the step of identifying the storage part containing the item to be delivered comprises the step of determining whether the connecting part is currently connecting the delivery platform and said storage part, and wherein the conveying step comprises the step of moving at least part of the connecting part so as to interconnect the delivery platform and said storage part in case the connecting part is not currently connecting the delivery platform and said storage part.

57. A method according to claim 55, the system further comprising a printing device, the method further comprising the step of the printing device printing a receipt to the customer.

58. A method according to claim 55, the method further comprising the step of advising the customer that an item is to be delivered at the item delivery system.

59. A method according to claim 58, wherein the advising step is performed using a global computer network.

60. A method according to claim 58, wherein the advising step is performed by the system sending a message to a cellular telephone.

61. A method according to claim 55, the system further comprising a payment device for receiving payment from a customer, the method further comprising the step of the customer providing payment before the item is delivered.

62. A method according to claim 61, the payment device comprising a card reader for reading information from credit cards, the method further comprising the steps of
the customer entering a credit card into the payment device,
the control unit validating the credit card, and
the control unit charging the credit card in case the credit card is valid.

63. A method according to claim 62, the system being connected to a global computer network, wherein the validating step is performed using the global computer network.

64. A method of performing maintenance and/or service on an item check-in and/or delivery system, the system comprising a control unit having means for communicating with service personnel, the method comprising the steps of
the service personnel establishing an electronic connection between an electronic service tool and the control unit of the system,
the service personnel performing the maintenance and/or service required via the established electronic connection using the electronic service tool, and
the service personnel disrupting the established connection.

65. A method according to claim 64, wherein the step of establishing an electronic connection comprises establishing a connection between a central computer positioned at a service centre and the control unit of the system by means of a global computer network.

66. A method according to claim 64, wherein the step of establishing an electronic connection comprises establishing a wireless connection between the electronic service tool and the control unit of the system.

67. A method according to claim 66, wherein the step of establishing a wireless connection comprises the establishing an infrared connection between the electronic service tool and the control unit of the system.

68. A method according to claim 64, wherein the step of establishing an electronic connection comprises establishing a connection via a telecommunication network.

69. A method according to claim 64, wherein the step of establishing an electronic connection comprises establishing a connection between a first central computer positioned at a service centre and a second central computer being connected to a plurality of item check-in and delivery systems, the system needing maintenance and/or service being one of said plurality of systems.

70. A method according to claim 64, wherein the step of performing the maintenance and/or service required comprises preparation in connection with on-location maintenance and/or service.

71. A method according to claim 64, the system further comprising a weighting unit for weighting the items being checked in or delivered, wherein the step of performing maintenance and/or service comprises the step of calibrating the weighting unit.

72. A method according to claim 64, wherein the step of performing maintenance and/or service comprises installation of software in the control unit of the system.
